(19) United States
(12) Patent Application Publication
(10) Pub. No.: US 2006/0141996 A1
(43) Pub. Date: Jun. 29, 2006

(54) Device and method for telephone number search in mobile terminal

(75) Inventor: Yun-Goo Huh, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/304,098

(22) Filed: Dec. 15, 2005

(30) Foreign Application Priority Data
Dec. 15, 2004 (KR) 2004-106532

(51) Int. Cl. H04Q 7/22; H04Q 7/38

(52) U.S. Cl. 455/414.1

(57) ABSTRACT

Disclosed is a device and method for searching for telephone numbers in a mobile terminal. The device includes a phonebook for storing telephone numbers dialed or received in a specific area, together with the number of calls to or from each of the telephone numbers; a user input unit for allowing a user to input a command for a telephone number search; a display unit for displaying one or more telephone numbers; and a control unit for storing a telephone number of an outgoing or incoming call together with a current location of the mobile terminal in the phonebook and, in response to the command for a telephone number search, delivering the telephone numbers stored in the phonebook to the display unit.

### PRIORITY

This application claims priority to an application entitled “Device and Method for Telephone Number Search in Mobile Terminal” filed with the Korean Intellectual Property Office on Dec. 15, 2004 and assigned Serial No. 2004-106532, the contents of which are incorporated herein by reference.

### BACKGROUND OF THE INVENTION

1. Field of the Invention

The present invention relates to a device and method for searching a phonebook in a mobile terminal, and more particularly to a device and method for searching for telephone numbers dialed or received on a mobile terminal in a specific area.

2. Description of the Related Art

To make an outgoing call or send a short message using a mobile terminal, a user may directly input a telephone number of an intended recipient or search for the telephone number in a phonebook stored in the mobile terminal. It takes time and effort to search for a desired telephone number in the phonebook that merely lists previously registered telephone numbers.

### SUMMARY OF THE INVENTION

Accordingly, the present invention has been made to solve the above-mentioned problems occurring in the prior art, and provides a device and method for searching for telephone numbers dialed or received on a mobile terminal in a specific area.

Also, the present invention provides a device and method for storing telephone numbers dialed or received on a mobile terminal in a specific area in a phonebook in such a manner that the numbers are arranged according a predetermined condition, and searching for the telephone numbers.

In accordance with one aspect of the present invention, there is provided a device for searching for telephone numbers in a mobile terminal, which includes a phonebook for storing telephone numbers dialed or received in a specific area, together with the number of calls to or from each of the telephone numbers; a user input unit for allowing a user to input a command for a telephone number search; a display unit for displaying one or more telephone numbers; and a control unit for storing a telephone number of an outgoing or incoming call together with a current location of the mobile terminal in the phonebook and, in response to the command for a telephone number search, delivering the telephone numbers stored in the phonebook to the display unit.

In accordance with another aspect of the present invention, there is provided a method for searching for telephone numbers in a mobile terminal that includes a memory storing telephone numbers of previous incoming or outgoing calls together with locations where the incoming or outgoing calls took place, the method including checking whether a user has inputted a command for a telephone number search; when the command is inputted, determining a current location of the mobile terminal; and searching for one or more telephone numbers corresponding to the current location among the telephone numbers stored in the memory and displaying the searched telephone numbers.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a mobile terminal according to the present invention;

FIG. 2 is a flow chart showing a process of registering a telephone number dialed or received on a mobile terminal in a specific area according to the present invention; and

FIG. 3 is a flow chart showing a process of searching for telephone numbers in a mobile terminal according to the present invention.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

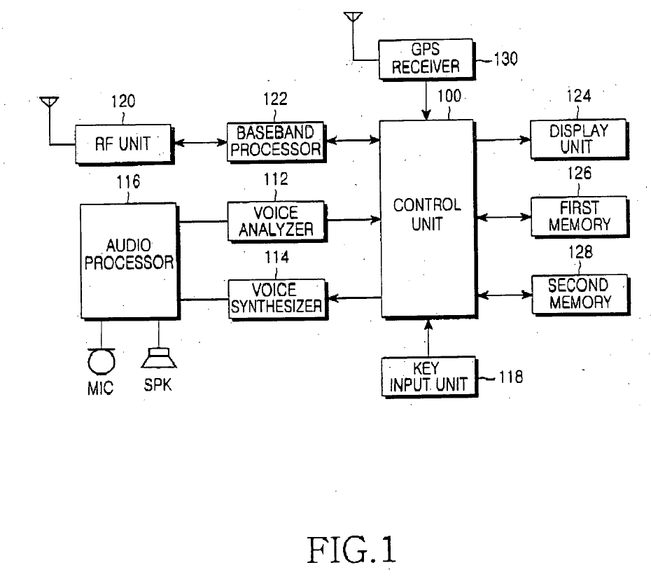

FIG. 1 is a block diagram of a mobile terminal according to the present invention, which preferably has a basic telephone function and at least one additional function such as a digital camera, digital multimedia broadcasting, an MP3 player, telematics, etc. In the following description, however, the basic telephone function of the mobile terminal will only be explained with reference to the present invention.

When a user makes an outgoing call or receives an in coming call, a control unit 100 stores the corresponding telephone number and the current location of the mobile terminal in a phonebook. The incoming or outgoing call may relate to voice communication or a messaging service such as a short message, multimedia messaging, mobile instant messaging or email, for example. When the user wishes to search for telephone numbers that have been dialed or received in the current location, from the phonebook, he or she may input a command for a telephone number search. Then the control unit 100 searches the phonebook that stores telephone numbers grouped according to the areas in which they were dialed or received. Upon detecting the telephone numbers that have been dialed or received in the current location among those stored in the phonebook, the control unit 100 displays the detected telephone numbers on a display unit 124. Whenever the number of calls to or from any telephone number in a specific area is increased, the control unit 100 rearranges the telephone numbers grouped according to the specific area in the phonebook. Also, the control unit 100 may display those telephone numbers on the display unit in descending order from the most frequently used telephone number to the least used one. The control unit 100 can be a Qualcomm MSM (Mobile Station Modem) chip.

A GPS (Global Positioning System) receiver 130 receives GPS information. The control unit 100 determines the current location of the mobile terminal based on the received GPS information.

A first memory 126 includes a ROM and a RAM for storing a plurality of programs and data necessary for the operations of the mobile terminal. A second memory 128 includes a conventional phonebook and another phonebook that stores telephone numbers grouped according to the areas in which they were dialed or received according to the present invention. The two phonebooks can be integrated into one.

An RF unit 120 comprises an RF transmitter for performing upward conversion and amplification of the frequency of a transmitted signal and an RF receiver for amplifying a received signal with low noise and performing downward conversion of the frequency of the signal. The RF unit 120 converts a received baseband signal from baseband processor 122 into an IF (intermediate frequency) signal and then into an RF signal which will be transmitted to a base station through an antenna. Also, the RF unit 120 converts an RF signal received from the base station through the antenna into an IF signal and then into a baseband signal. As an interface between the control unit 100 and the RF unit 120, a baseband processor 122 processes a baseband signal. When a microphone MIC converts the user's speech into an electric signal, an audio processor 116 performs pulse code modulation (PCM) on the electric signal, and passes the PCM signal to the control unit 200 through voice analyzer 112. Also, the audio processor 116 converts a pulse code modulated signal received from control unit 100 through voice synthesizer 114 into an electric signal to output audible sound through a speaker SPK.

Key input unit 118 and display unit 124 are means of user interface. The key input unit 118 is provided with a plurality of keys, including number keys for inputting telephone numbers or characters, function keys for implementing various functions available on the mobile phone, direction keys for moving a cursor and other keys such as a select key. When any key input is detected, the key input unit 118 transfers corresponding data to the control unit 100. The display unit 124 can be an LCD (Liquid Crystal Display) device, and displays the current state of the mobile terminal, menus, telephone number inputted or searched for and other information under the control of the control unit 100. Also, the display unit 124 may comprise a touch screen.

The current location of the mobile terminal can be determined using a location-based service. In other words, the current location can be determined based on the information about the nearest base station or the GPS information received by the GPS receiver 130.

The location of a mobile terminal can be determined based on the base station information being broadcast over a pilot channel. This location determination method considers the nearest base station (or the currently serving base station) as the current location of the mobile terminal. Since there is a possibility that the mobile terminal is not connected to the nearest base station, this location determination may have a great error range between the actual mobile terminal location and the base station location. By contrast, in the location determination with the GPS receiver 130, the error range is relatively small (less than 10 m) because at least three GPS satellites are used to calculate the exact time and distance and thereby track the precise location of the mobile terminal.

In a preferred embodiment of the present invention, the location determination method with GPS is used. Of course, it is possible to increase the accuracy of the location determination using both methods. Since the location determination itself is not significant in the present invention, a detailed explanation thereof will not be given.

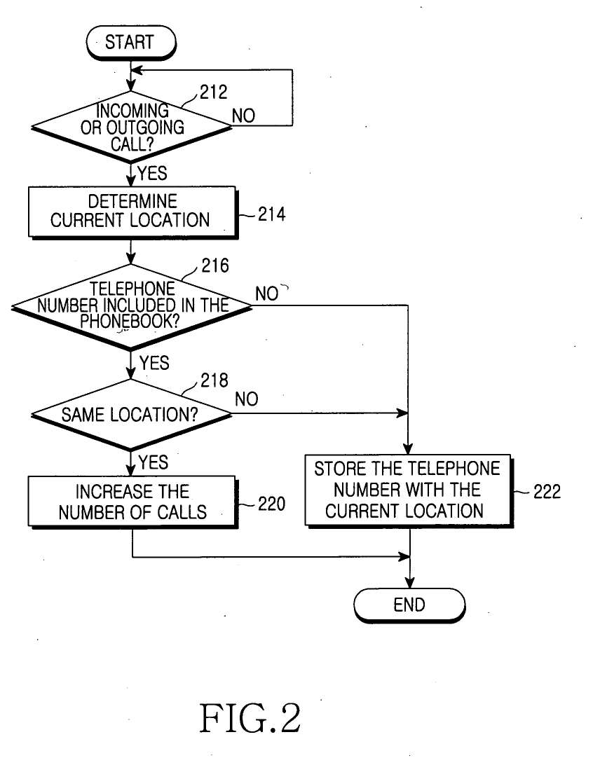

FIG. 2 is a flow chart showing a process of registering a telephone number dialed or received on a mobile terminal in a specific area according to the present invention.

When the user originates or receives a call or sends or receives a short message, multimedia message, instant message or email in a specific area, the corresponding telephone number is registered together with the current location of the mobile terminal in the specific area. When the telephone number has been previously registered, the number of calls to or from the telephone number is increased by one.

At step 212, the control unit 100 checks whether an incoming or outgoing call has been completed. Upon completion of the incoming or outgoing call, the control unit 100 proceeds to step 214 to determine the current location of the mobile terminal based on GPS information received by the GPS receiver 130. At step 216, the control unit 100 determines whether the telephone number of the incoming or outgoing call is included in the phonebook (i.e., the phonebook storing telephone numbers grouped according to areas). If in the affirmative, the control unit 100 proceeds to step 218 to determine whether the registered location information corresponding to the telephone number is identical to the current location of the mobile terminal. If in the affirmative, the control unit 100 updates the phonebook at step 220 by increasing the number of calls to or from the telephone number by one and then terminates the telephone number registration process.

If the control unit 100 determines that the telephone number of the incoming or outgoing call is not included in the phonebook at step 216, or if the control unit 100 determines that the registered location information is not identical to the current location of the mobile terminal at step 218, the control unit 100 will store the telephone number of the incoming or outgoing call in the phonebook, together with the current location of the mobile terminal.

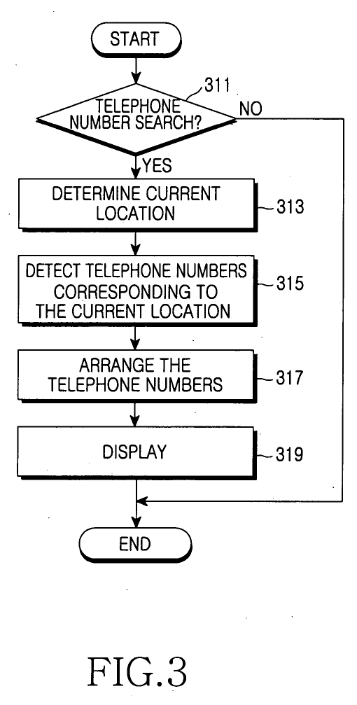

FIG. 3 is a flow chart showing a process of searching for telephone numbers in a mobile terminal according to the present invention.

In response to the user's command for a telephone number search, the mobile terminal searches the telephone numbers, stored in the phonebook by a process as shown in FIG. 2, to detect one or more telephone numbers registered and displays the detected telephone numbers on the display unit. This search method enables the user to rapidly search for the telephone numbers frequently used in a specific area, thereby improving user convenience. The telephone numbers previously dialed or received on the mobile terminal in the area where the user is currently located in relation to incoming or outgoing calls or messaging services such as short message, multimedia message, instant message or email are preferably displayed on the display unit in descending order from the most frequently used telephone number to the least used one. Accordingly, it is possible to shorten the time to search for a desired telephone number using a mobile terminal usage pattern in a specific area.

At step 311, the control unit 100 checks whether the user has inputted a command to search the phonebook (i.e., the phonebook storing telephone numbers grouped according to areas). When the command is inputted, the control unit 100 proceeds to step 313 to determine the current location of the mobile terminal based on GPS information received by the GPS receiver 130. At step 315, the control unit 100 detects any telephone numbers corresponding to the current location from the phonebook. At step 317, the control unit 100 arranges the detected telephone numbers according to a predetermined condition. At step 319, the control unit 100 transfers the arranged telephone numbers to the display unit.

The predetermined condition can be the number of calls made to or received from the telephone numbers in the same area. Also, the detected telephone numbers can be arranged in descending order from the most frequently used telephone number to the least used one.

As explained above, it is possible to easily and rapidly search for a desired telephone number using a mobile terminal usage pattern in a specific area. In other words, when the user inputs a command for a telephone number search in a specific area, the mobile terminal searches for the telephone numbers which have been dialed or received in the same area in relation to incoming or outgoing calls or messaging services such as short message, multimedia message, instant message and email. The mobile terminal displays the detected telephone numbers in descending order from the most frequently used telephone number to the least used one to improve user convenience and shorten the time to search for a desired telephone number.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A device for searching for telephone numbers in a mobile terminal, which comprises:
a phonebook for storing telephone numbers dialed or received in a specific area, together with the number of calls to or from each of the telephone numbers;
a user input unit for allowing a user to input a command for a telephone number search;
a display unit for displaying one or more telephone numbers; and
a control unit for storing a telephone number of an outgoing or incoming call together with a current location of the mobile terminal in the phonebook and, in response to the command for a telephone number search, delivering the telephone numbers stored in the phonebook to the display unit.

2. The device as claimed in claim 1, wherein said display unit displays telephone numbers arranged in a specific order according to the number of calls to or from each of the telephone numbers.

3. The device as claimed in claim 2, wherein said control unit rearranges the telephone numbers whenever the number of calls to or from each of the telephone numbers is increased.

4. The device as claimed in claim 2, wherein said control unit arranges the telephone numbers read out from the phonebook in descending order from the most frequently used telephone number to the least used one and transfers the arranged telephone numbers to the display unit.

5. The device as claimed in claim 1, wherein said current location is determined using a location-based service.

6. The device as claimed in claim 5, wherein said current location is determined using base station information.

7. The device as claimed in claim 5, further comprising a GPS receiver, wherein said current location is determined based on GPS information received by the GPS receiver.

8. The device as claimed in claim 1, wherein said incoming or outgoing call is for voice communication.

9. The device as claimed in claim 1, wherein said incoming or outgoing call is one of a short message, multimedia message, instant message and email.

10. A method for registering a telephone number in a mobile terminal, comprising the steps of:
determining whether an incoming or outgoing call has been completed; and
upon completion of the incoming or outgoing call, determining a current location of the mobile terminal, and storing a corresponding telephone number together with the current location.

11. The method as claimed in claim 10, further comprising:
determining whether the corresponding telephone number has already been stored; and
if the telephone number has been stored, increasing the number of calls to or from the telephone number by one.

12. The method as claimed in claim 11, further comprising:
arranging telephone numbers according to the number of calls to or from each of the telephone numbers in the same area.

13. The method as claimed in claim 10, wherein said incoming or outgoing call is for voice communication.

14. The method as claimed in claim 10, wherein said incoming or outgoing call is one of a short message, multimedia message, instant message, and email.

15. A method for searching for telephone numbers in a mobile terminal that includes a memory for storing telephone numbers of previous incoming or outgoing calls together with locations corresponding to where the incoming or outgoing calls took place, said method comprising the steps of:
determining whether a user has input a command for a telephone number search;
when the command is input, determining a current location of the mobile terminal; and
searching for one or more telephone numbers corresponding to the current location among the telephone numbers stored in the memory and displaying the searched telephone numbers.

16. The method as claimed in claim 15, further comprising:
arranging the detected telephone numbers in a specific order according to the number of calls to or from each of the telephone numbers.

17. The method as claimed in claim 15, wherein said incoming or outgoing call is for voice communication.

18. The method as claimed in claim 15, wherein said incoming or outgoing call is one of a short message, multimedia message, instant message and email.
